(19) United States
(12) Patent Application Publication
(10) Pub. No.: US 2007/0160478 A1
(43) Pub. Date: Jul. 12, 2007

(54) Fan blade with non-varying stagger and camber angels

(75) Inventors: Yousef Jarrah, Tucson, AZ (US); Jonn Herzberger, Tempe, AZ (US); Desi Riedel, Phoenix, AZ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Minebea Co., Ltd., Tokyo (JP)

(21) Appl. No.: 11/643,324

(22) Filed: Dec. 20, 2006

Related U.S. Application Data
(60) Provisional application No. 60/755,473, filed on Dec. 29, 2005.

(51) Int. Cl. B64C 27/46

(52) U.S. Cl. 416/223 R

(57) ABSTRACT

A fan blade is described having a substantially non-varying stagger angle along its radial length. In one embodiment, a fan blade has a substantially non-varying stagger angle and a substantially non-varying camber angle along its radial length. In another embodiment, each airfoil section of the blade has at least substantially the same stagger angle or substantially the same camber angle.

### CROSS-REFERENCES TO RELATED APPLICATIONS

The present application claims priority from U.S. Provisional Application No. 60/755,473, filed Dec. 29, 2005, and is fully incorporated herein by reference for all purposes.

### BACKGROUND OF THE INVENTION

The present invention relates generally to cooling fans and in particular to fan blade designs for use in cooling fans.

According to theory and known literature, fan blades must have varying stagger and camber angle profiles along the radial direction. Known fan blades are designed with stagger angles that increase with radius (as measured from the hub to the blade tip), and most fan blades are designed with camber angles that decrease with radius.

### BRIEF SUMMARY OF THE INVENTION

A fan blade for any fan frame size according to the present invention is designed with a shape having a non-varying stagger angle and non-varying camber angle along the radial coordinate. In other words, the cross-sectional shape of the fan blade does not change along its radial direction. This easy-to-produce blade captures the maximum flow possible for a given fan size and a given rotational speed, and reduces the noise level by a few dB. The blade is easy to manufacture because the molding is simple; the blade material is injected into the mold and finished blade can be easily removed.

We invented this blade for small fans with tiny blade heights. The idea was that for tiny blades the incoming flow does not really differentiate between the radial sections and it really sees a “body”; thus we selected single “average” values for both the stagger and the camber angles. When we tested small fans they unexpectedly performed very well. Over time we applied the same idea for larger and larger fan blades. It was discovered that that the fan blade design of the present invention increases performance for all fan blade sizes.

### BRIEF DESCRIPTION OF THE DRAWINGS

FIG. 1A is a perspective view of an impeller component of a fan in accordance with the present invention.

FIG. 1B is a top view of an impeller component, illustrating aspects of a fan blade of the present invention.

FIG. 2 illustrates a cooling fan embodied in accordance with the present invention.

FIG. 3 shows a pressure/flow graph comparing the performance of a conventional fan blade and a fan blade of the present invention.

FIG. 4 shows the parameters of an airfoil section.

### DETAILED DESCRIPTION OF THE INVENTION

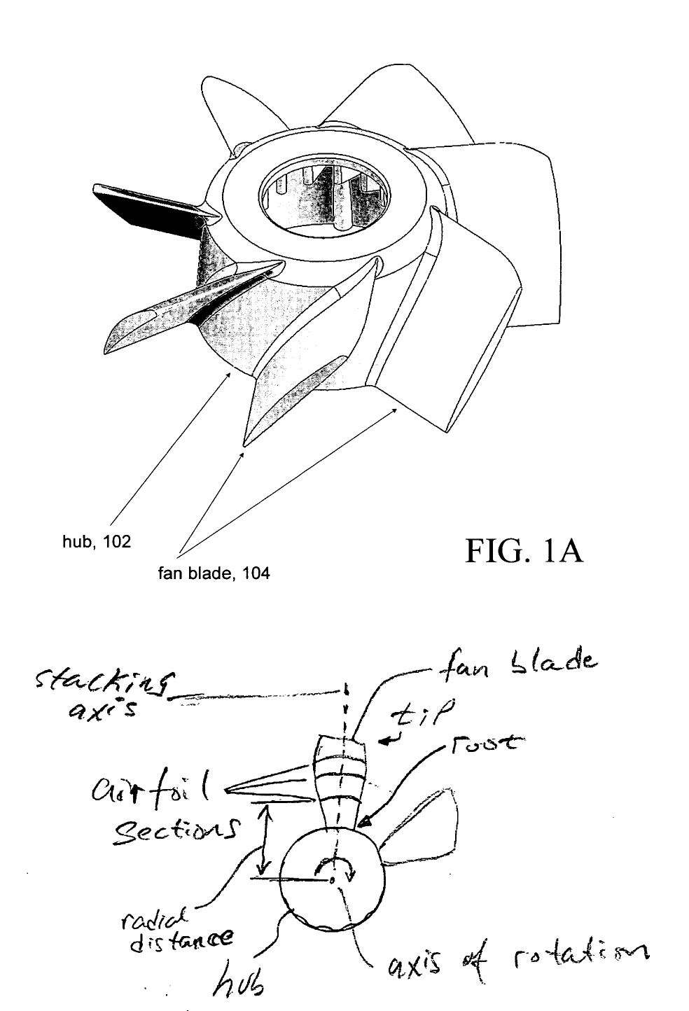

FIG. 1A shows an impeller component according to the present invention comprising a hub 102 and fan blades 104 disposed about the hub. In accordance with the present invention, the fan blades 104 are designed with a substantially non-varying stagger angle and a substantially non-varying camber angle. In one embodiment of the present invention, each fan blade 104 shares this design characteristic. In other embodiments, fewer than all of the fan blades have this design characteristic.

FIG. 1B illustrates with further detail a fan blade design according to the present invention. FIG. 1B show a top view of an impeller component. The hub is shown with its axis of rotation and direction of rotation. A fan blade attaches to the hub at its root. A fan blade is conventionally described by a series of cross-sectional views referred to as airfoil sections. Thus, given some number N of airfoil sections, the fan blade may be defined by stacking the airfoil sections and interpolating values between airfoil sections. The number of airfoil sections that is used to specify a fan blade depends on the size of the fan blade and the desired degree of accuracy, and can range from five sections to hundreds of sections. As understood by those of ordinary skill, each airfoil section is taken along a stacking axis from the hub.

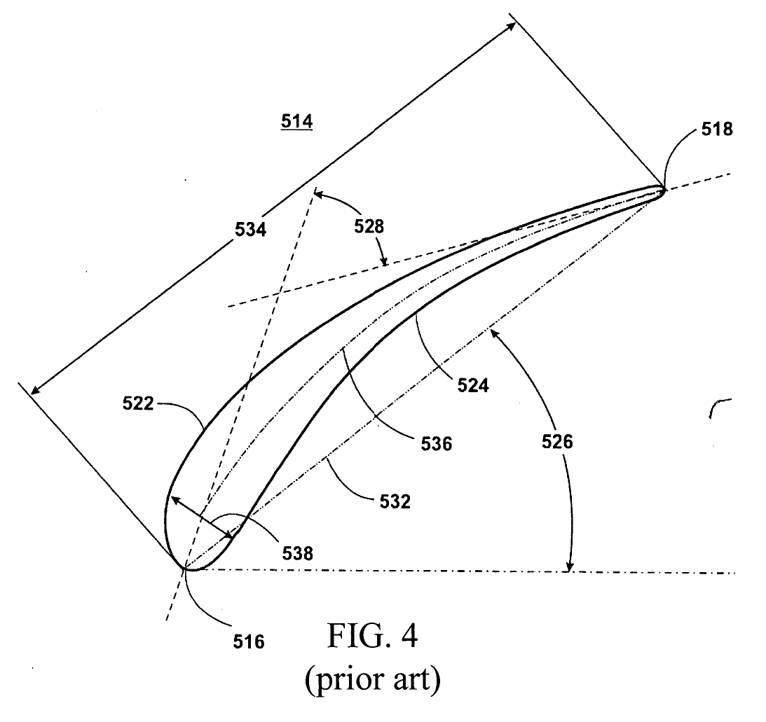

Each airfoil section is characterized by parameters such as shown in FIG. 4. The airfoil section 514 shown in FIG. 4 is taken along a radial line (stacking axis) from the hub. Each airfoil section 514 of the fan blade has a leading edge 516, a trailing edge 518, an upper surface 522, and a lower surface 524. The airfoil section 514 may be further defined by the stagger angle 526, the camber angle 528, a chord line 532, its chord length 534, a mean camber line 536, and a thickness 538 measurement. In prior art fans, the stagger angle and the camber angle of the fan blade both vary along the radial direction from the hub to the blade tip.

In the discussion of the present invention, an airfoil section is identified with respect to it radial distance from the hub. A convenient point of reference is the distance measured from the axis of rotation, as illustrated in FIG. 1B.

Thus, airfoil sections of a fan blade in accordance with the present invention, each has substantially the same stagger angle as the other airfoil sections and each has substantially the same camber angle as the other airfoil sections. Stated differently, the stagger angle and camber angle are substantially unchanged from one airfoil section of a fan blade to the another airfoil section of the same fan blade. Stated yet in another way, the fan blade is characterized by a substantially constant blade stagger angle and a substantially constant blade camber angle. The blade stagger angle (one value throughout) is selected to capture the maximum flow possible, and the blade camber angle (one value throughout) is selected to produce pressure efficiently.

In yet another embodiment of the present invention, a fan blade is characterized at least by having a substantially non-varying blade stagger angle along the radial length of the fan blade, while the camber angle may vary. In other words, the airfoil sections of a fan blade in accordance with the present invention, each has substantially the same stagger angle as the other airfoil sections.

In still yet another embodiment of the present invention, a fan blade is characterized at least by having a substantially non-varying blade camber angle along the radial length of the fan blade, while the stagger angle may vary. In other words, the airfoil sections of a fan blade in accordance with the present invention, each has substantially the same camber angle as the other airfoil sections.

It was discovered that fan blade designs according to the present invention are effective with small size fans (diameter less than 60 mm), medium size fans (diameter between 60 to 120 mm), and large size fans (diameter over 120 mm).

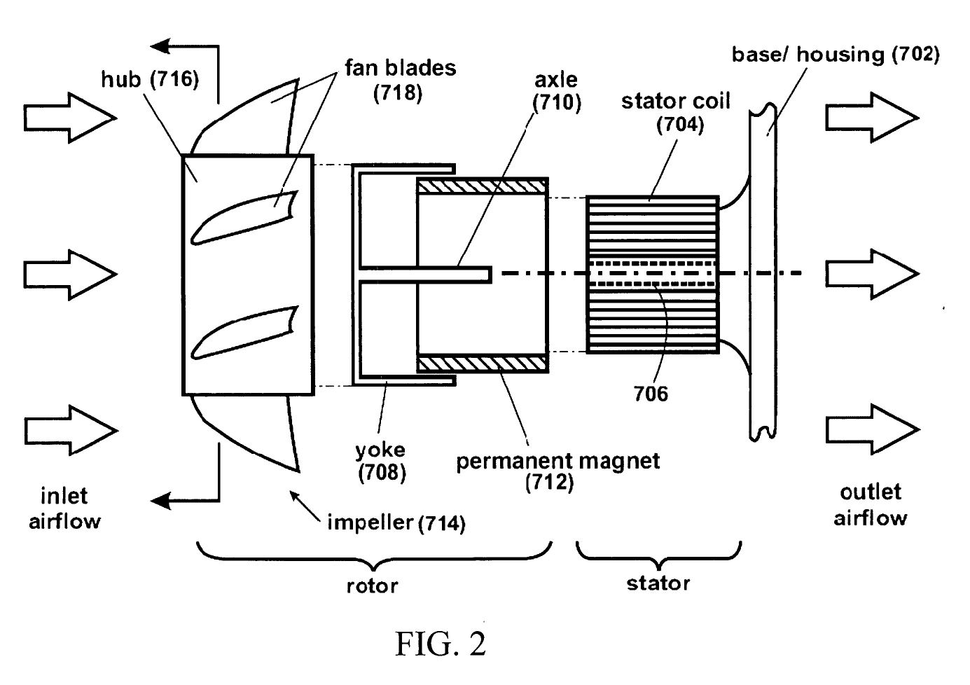

FIG. 2 illustrates a fan according to the present invention. The figure shows an impeller component 714 comprising a plurality of fan blades 718 disposed about a hub 716. At least some of the fan blades 718 are formed according to the present invention. Thus, for at least one of the fan blades 718 are characterized in that at least the stagger angle of each constituent airfoil sections is substantially the same. In another embodiment, both the stagger angle for each airfoil section of the fan blade 718 is substantially the same and the camber angle for each airfoil section of the fan blade is substantially the same.

Continuing with FIG. 2, a yoke assembly comprises a yoke element 708 and an annular permanent magnet 712 that fits within the yoke element. The yoke element 708 includes a shaft 710. The yoke assembly is fixed within the hub 716. The impeller and yoke assembly can be referred to variously as the fan rotor, rotor assembly, or simply the rotor. A stator coil 704 comprises a plurality of coil windings mounted to a mounting plate 702, typically the base plate of a fan housing. The shaft 710 is received within a central channel 706 (indicated by the dashed lines) that is provided through the center of stator coil 704. The base plate 702 supports the shaft and provides a bearing surface to allow the shaft to rotate about an axis of rotation defined by the shaft. Alternatively, the shaft can be supported on a bearing liner fitted within the central channel.

When the stator coils are suitably activated, the fan rotor will rotate. Airflow directions are shown comprising at least an axial inlet airflow and at least an outlet airflow. Strictly speaking, the disclosed yoke assembly and stator coil combination constitute a motor (in this case a brushless DC motor). Other motor configurations are possible.

In accordance with an embodiment of the present invention, the camber angle and the stagger angle of the airfoil sections which constitute a fan blade are substantially constant for each airfoil section.

In other embodiments of the present invention, the camber angle and the stagger angle of the airfoil sections which constitute a fan blade do not vary substantially from one airfoil section to the next.

In another embodiment of the present invention, the camber and stagger angles of the airfoil sections which constitute a fan-blade vary by no more than five degrees.

In other embodiments of the present invention, the camber angle of the airfoil sections which constitute a fan blade remains substantially constant while the stagger angle varies by no more than five degrees.

In other embodiments of the present invention, the stagger angle of the airfoil sections which constitute a fan blade remains substantially constant while the camber angle varies by no more than five degrees.

It will be appreciated that not every cross section of the fan blade needs to meet the stagger angle and/or camber angle property disclosed above. For example, the portions of the fan blade near the root and near the blade tip do not contribute significantly to the performance of the fan blade. Consequently, these portions of the fan blade may have stagger angles and camber angles that vary.

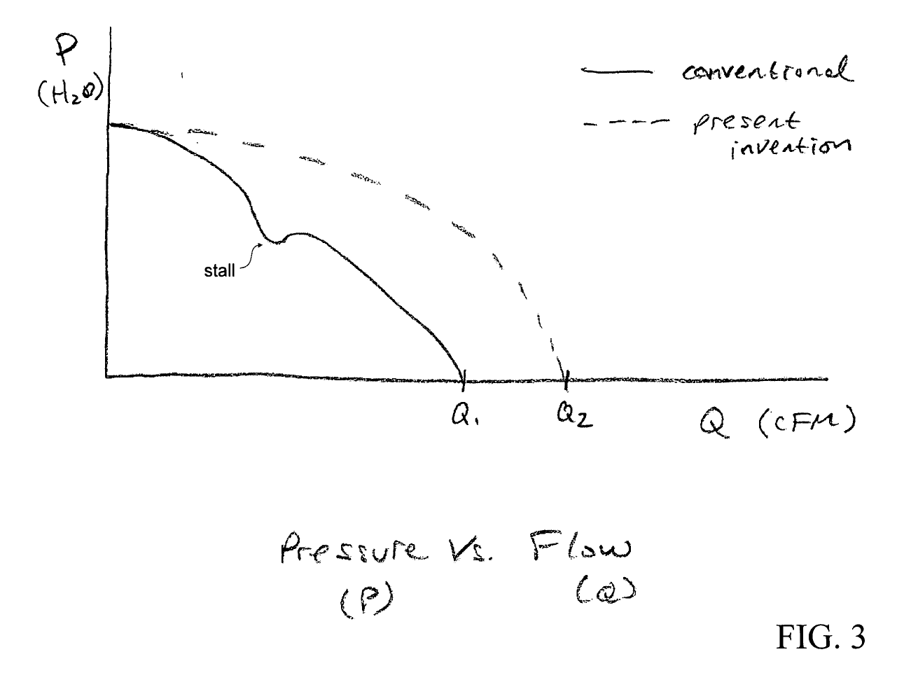

FIG. 3 is a flow-pressure chart showing air flow expressed as cubic feet per minute (CFM) versus pressure (inches of H₂O), for a given fan size operating at a given speed (RPM—rotations per minute). The solid line shows a typical flow profile for conventional fan blade designs. The dashed line shows a typical profile for a fan designed in accordance with the present invention. Tests have shown a significant increase of air flow in the free air condition (i.e., pressure is zero) with fan blades according to the present invention as compared to conventional fan blades. The conventional fan blade exhibits a stall condition as can be seen by the bump in the curve. By comparison, the fan blade of the present invention does not exhibit such a condition.

It is understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A cooling fan comprising:
an impeller,
the impeller comprising a hub element and a plurality of fan blades disposed about the hub element,
at least one of the fan blades comprising airfoil sections wherein the camber angle and the stagger angle are substantially constant among the airfoil sections.

2. The cooling fan of claim 1 wherein each of the fan blades comprises airfoil sections wherein the camber angle and the stagger angle are substantially constant among the airfoil sections.

3. The cooling fan of claim 1 wherein the camber and stagger angles are substantially constant for airfoil sections from near the fan blade root to near the fan blade tip.

4. A cooling fan comprising:
an impeller comprising a hub and a plurality of fan blades disposed about the hub,
at least one of the fan blades comprising airfoil sections wherein the camber angles among the airfoil sections are substantially within five degrees of each other and wherein the stagger angles among the airfoil sections are substantially within five degrees of each other.

5. A cooling fan comprising:
an impeller comprising a hub element and a plurality of fan blades disposed about the hub element; and
a motor connected to the hub to rotate the impeller,
at least one of the fan blades comprising airfoil sections wherein the camber angles among the airfoil sections are substantially within five degrees of each other and wherein the stagger angle does not vary substantially among the airfoil sections.

6. A cooling fan comprising an impeller comprising a plurality of fan blades, wherein at least one of the stagger angle or the camber angle does not vary substantially among airfoil sections of at least one of the fan blades.

7. A cooling fan comprising an impeller comprising a plurality of fan blades, wherein at least one of the stagger angle or the camber angle is substantially within five degrees of each other among airfoil sections of at least one of the fan blades.

8. A cooling fan comprising:
an impeller comprising a hub element and a plurality of fan blades disposed about the hub element; and
a motor connected to the hub to rotate the impeller,
at least one of the fan blades comprising airfoil sections wherein one of the stagger angle or the camber angle does not vary substantially along its radial direction and wherein the other of the stagger angle or the camber angle varies by no more than five degrees along its radial direction.

9. A cooling fan comprising one or more fan blades that are characterized by having airfoil sections with substantially constant camber and stagger angles among the airfoil sections, wherein the air flow in the free air condition is at least ten percent higher than the air flow of a fan which blades have a substantially non-constant camber angle and substantially non-constant stagger angle.

10. A fan assembly comprising:
a drive device;
a hub member coupled to the drive device, the hub member aligned along an axial orientation; and
a plurality of main blade members operably coupled to the hub member, the plurality of main blade members being adapted to capture flow at a fan inlet and output the captured flow at a fan outlet,
wherein at least one of the blade members has at least a substantially constant camber angle along its radial direction or a substantially constant stagger angle along its radial direction.

11. The fan assembly of claim 10 wherein both the stagger angle and the camber angle are substantially constant along the radial direction of said at least one blade member.

12. The fan assembly of claim 10 wherein each of the blade members has at least a substantially constant camber angle along its radial direction or a substantially constant stagger angle along its radial direction.

13. The fan assembly of claim 10 wherein each of the plurality of blade members being capable of producing at least 10 percent more flow volume relative to a blade member having a varying camber angle.

14. A fan assembly comprising:
a drive device;
a hub member coupled to the drive device, the hub member provided in an axial orientation; and
a plurality of main blade members operably coupled to the hub member, the plurality of main blade members being adapted to capture flow at an inlet and output the captured flow at an outlet,
wherein each of the plurality of blade members has a substantially constant camber angle and a substantially constant stagger angle so that on a plot of pressure versus flow during fan operation, there is no stall condition.
